(19) United States
(12) Patent Application Publication
(10) Pub. No.: US 2025/0039895 A1
(43) Pub. Date: Jan. 30, 2025

(54) TIMING PARAMETERS FOR MULTI-DOWNLINK CONTROL INFORMATION- BASED MULTI-TRANSMIT-RECEIVE-POINT CONFIGURATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/716,736

(22) PCT Filed: Feb. 2, 2022
(86) PCT No.: PCT/CN2022/075306

§ 371 Date: Jun. 5, 2024

(51) Int. Cl. H04W 72/231; H04W 56/00; H04W 72/0446

(52) U.S. Cl. CPC H04W 72/231; H04W 56/0045; H04W 72/0446

(57) ABSTRACT

Various aspects of the present disclosure generally relate to wireless communication. In some aspects, a user equipment (UE) may communicate, based at least in part on a multi-downlink control information (DCI)-based multi-transmit-receive-point (mTRP) configuration, with a first TRP in accordance with a first value, associated with the first TRP, of a timing parameter. The UE may communicate, based at least in part on the multi-DCI-based mTRP configuration, with a second TRP in accordance with a second value, associated with the second TRP, of the timing parameter. Numerous other aspects are described.

### FIELD OF THE DISCLOSURE

Aspects of the present disclosure generally relate to wireless communication and to techniques and apparatuses for timing parameters for multi-downlink control information-based multi-transmit-receive-point configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to communicate, based at least in part on a multi-downlink control information (DCI)-based multi-transmit-receive-point (mTRP) configuration, with a first TRP in accordance with a first value, associated with the first TRP, of a timing parameter. The one or more processors may be configured to communicate, based at least in part on the multi-DCI based mTRP configuration, with a second TRP in accordance with a second value, associated with the second TRP, of the timing parameter.

Some aspects described herein relate to a method of wireless communication performed by a UE. The method may include communicating, based at least in part on a multi-DCI-based mTRP configuration, with a first TRP in accordance with a first value, associated with the first TRP, of a timing parameter. The method may include communicating, based at least in part on the multi-DCI based mTRP configuration, with a second TRP in accordance with a second value, associated with the second TRP, of the timing parameter.

Some aspects described herein relate to a non-transitory computer-readable medium that stores a set of instructions for wireless communication by a UE. The set of instructions, when executed by one or more processors of the UE, may cause the UE to communicate, based at least in part on a multi-DCI-based mTRP configuration, with a first TRP in accordance with a first value, associated with the first TRP, of a timing parameter. The set of instructions, when executed by one or more processors of the UE, may cause the UE to communicate, based at least in part on the multi-DCI based mTRP configuration, with a second TRP in accordance with a second value, associated with the second TRP, of the timing parameter.

Some aspects described herein relate to an apparatus for wireless communication. The apparatus may include means for communicating, based at least in part on a multi-DCI-based mTRP configuration, with a first TRP in accordance with a first value, associated with the first TRP, of a timing parameter. The apparatus may include means for communicating, based at least in part on the multi-DCI based mTRP configuration, with a second TRP in accordance with a second value, associated with the second TRP, of the timing parameter.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of multi-transmit-receive-point (mTRP) operations, in accordance with the present disclosure.

FIG. 4 is a diagram illustrating an example associated with timing parameters for multi-downlink control information (DCI)-based mTRP configurations, in accordance with the present disclosure.

FIG. 5 is a diagram illustrating an example process associated with timing parameters for multi-DCI-based mTRP configurations, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

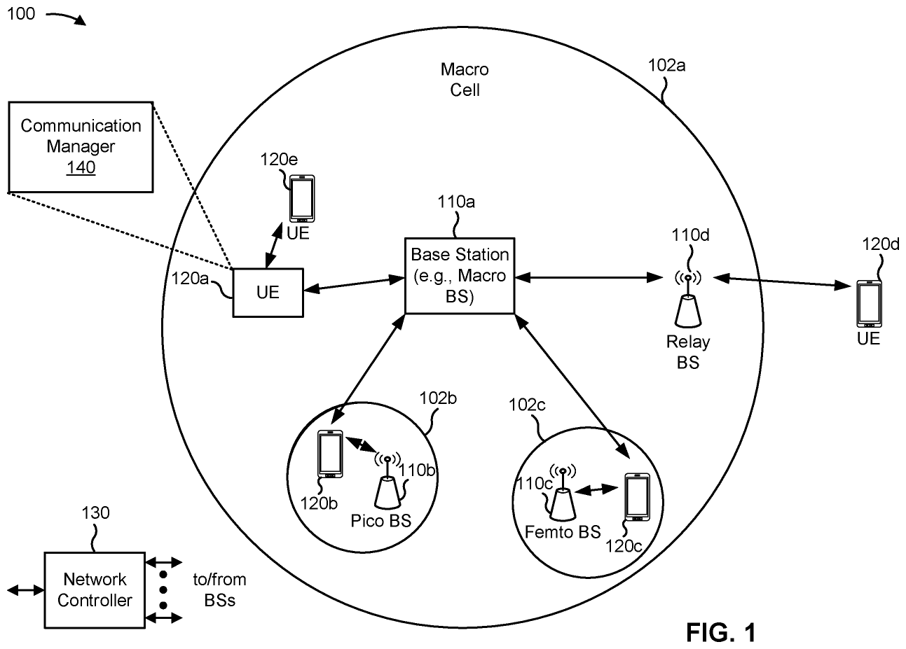

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit-receive-point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may communicate, based at least in part on a multi-downlink control information (DCI)-based multi transmit-receive-point (mTRP) configuration, with a first TRP in accordance with a first value, associated with the first TRP, of a timing parameter; and communicate, based at least in part on the multi-DCI-based mTRP configuration, with a second TRP in accordance with a second value, associated with the second TRP, of the timing parameter. Additionally, or alternatively, the communication manager 140 may perform one or more other operations described herein.

As indicated above, FIG. 1 is provided as an example. Other examples may differ from what is described with regard to FIG. 1.

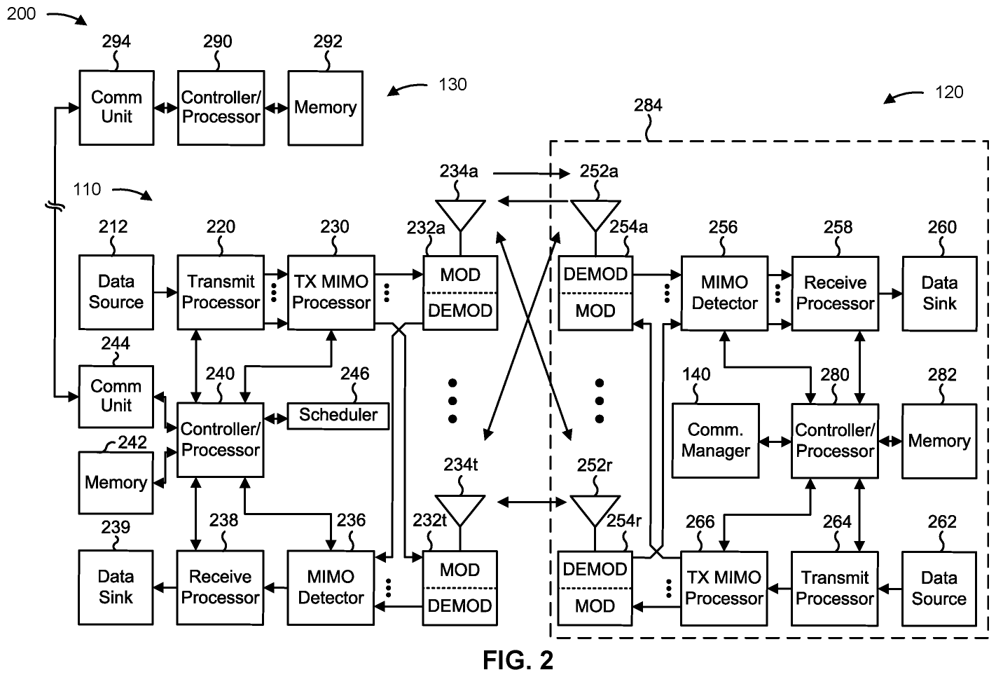

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “TRP” may refer to one or more components of a disaggregated base station. For example, in some aspects, “TRP” may refer to a control unit, a distributed unit, a plurality of control units, a plurality of distributed units, an antenna, an antenna panel, and/or a combination thereof. In some aspects, “TRP” may refer to one device configured to perform one or more functions such as those described above in connection with the base station 110. In some aspects, “TRP” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “TRP” may refer to any one or more of those different devices. In some aspects, “TRP” may refer to one or more virtual base stations, one or more virtual base station functions, and/or a combination of thereof. For example, in some cases, two or more base station functions may be instantiated on a single device. In some aspects, “TRP” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

Some UEs and/or base stations may support full duplex operation in which the UEs and/or the base stations support full duplex operations. For example, a UE may support transmission via a first beam (e.g., using a first antenna panel) and may simultaneously support reception via a second beam (e.g., using a second antenna panel). Support for simultaneous transmission and reception may be conditional on beam separation, such as spatial separation (e.g., using different beams), frequency separation, and/or the like. Additionally, or alternatively, support for simultaneous transmission may be conditional on using beamforming (e.g., in frequency range 2 (FR2), in frequency range 4 (FR4), for millimeter wave signals, and/or the like).

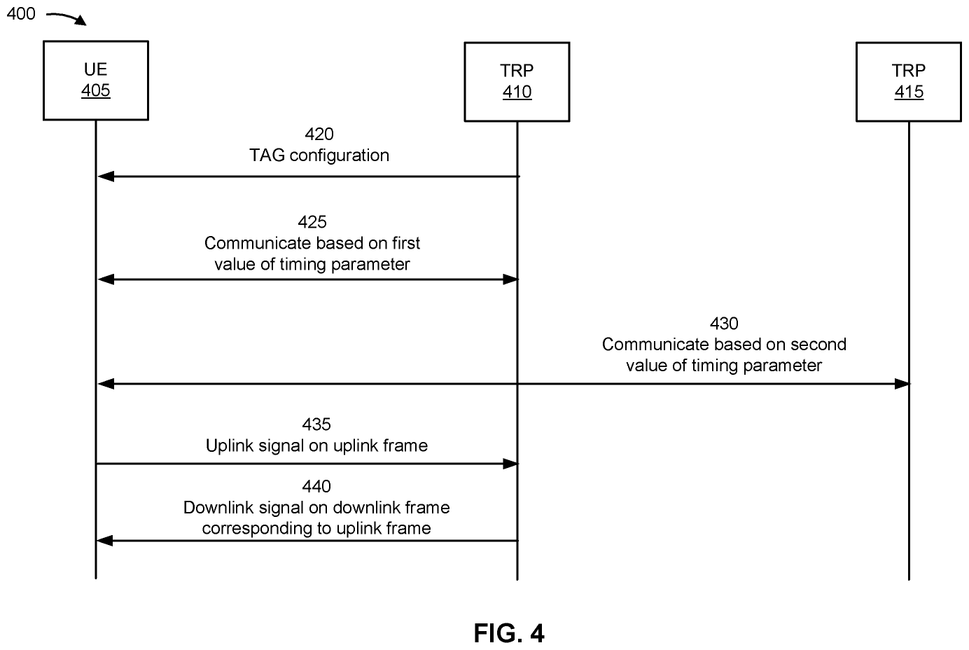

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

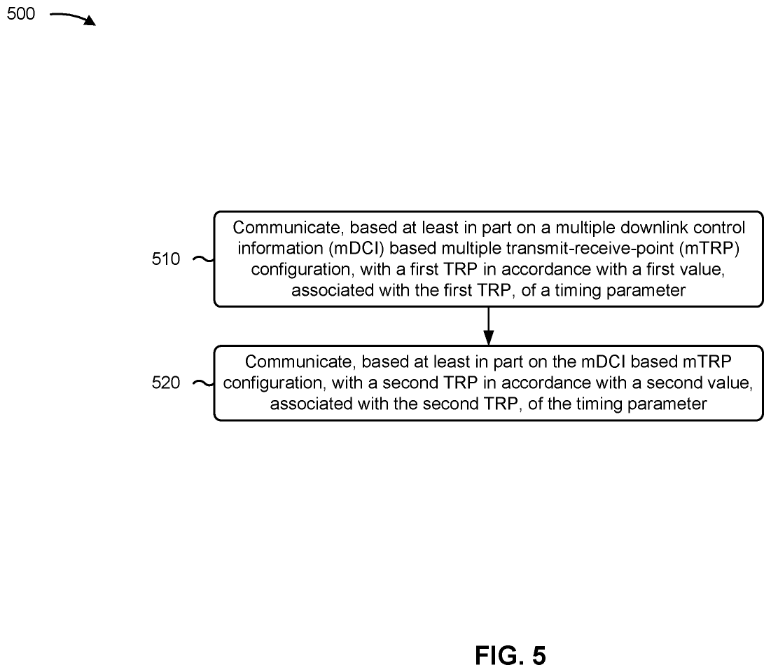

The controller/processor 240 of the base station 110, the controller/processor 280 of the UE 120, and/or any other component(s) of FIG. 2 may perform one or more techniques associated with timing parameters for multi-DCI-based mTRP configurations, as described in more detail elsewhere herein. In some aspects, the TRP described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, a UE (e.g., the UE 120) includes means for communicating, based at least in part on a multi-DCI-based mTRP configuration, with a first TRP in accordance with a first value, associated with the first TRP, of a timing parameter; and/or means for communicating, based at least in part on the multi-DCI based mTRP configuration, with a second TRP in accordance with a second value, associated with the second TRP, of the timing parameter. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

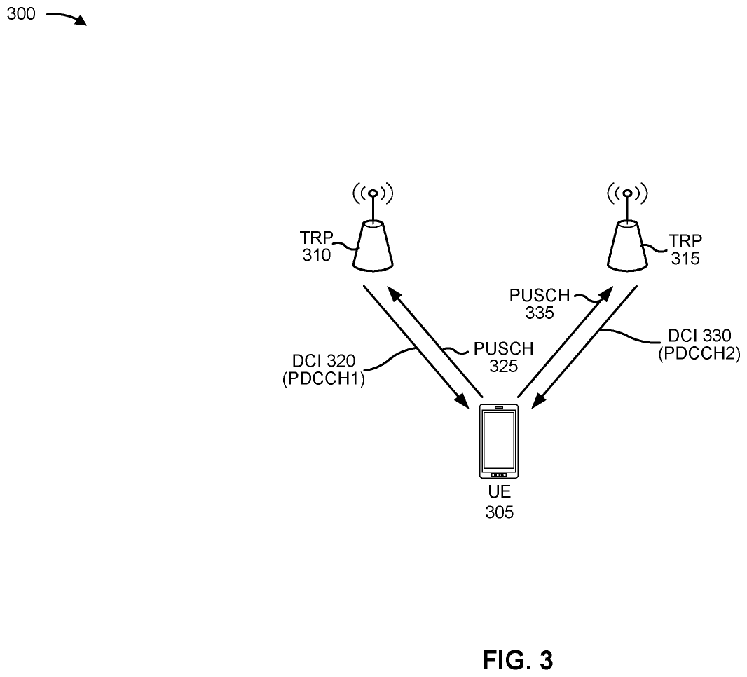

FIG. 3 is a diagram illustrating an example 300 of multi-DCI-based mTRP operation in accordance with the present disclosure. As shown, a UE 305 may communicate with a first TRP 310 and a second TRP 315. The UE 305 may be configured with multi-DCI-based mTRP operation. In some aspects, the TRP 310 and/or the TRP 315 may be, include, or be included in, one or more base stations 110 described above in connection with FIGS. 1 and 2. For example, different TRPs 310 and 315 may be included in different base stations 110. In some cases, multiple TRPs 310 and 315 may be included in a single base station 110. In some cases, a TRP 310 and/or a TRP 315 may be referred to as a cell, a panel, an antenna array, or an array. The UE 305 may be, include, or be included in the UE 120 described above in connection with FIGS. 1 and 2.

In some aspects, multiple TRPs 310 and 315 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). In some aspects, a TCI state may be used to indicate one or more QCL relationships. A TRP 310 may be configured to individually (for example, using dynamic selection) or jointly (for example, using joint transmission with one or more other TRPs 310) serve traffic to a UE 120.

The UE 305 may be configured with multi-DCI-based mTRP operation. As shown, when configured with multi-DCI-based multi-TRP operation, the UE 305 may receive, from the first TRP 310, a first DCI transmission 320 in a first physical downlink control channel (PDCCH) transmission (shown as “PDCCH1”), where the first DCI transmission 320 may schedule a first physical uplink shared channel (PUSCH) transmission 325 for transmitting to the first TRP 310. Similarly, the UE 305 may receive, from the second TRP 315, a second DCI transmission 330 in a second PDCCH (shown as “PDCCH2”), where the second DCI transmission 330 may schedule a second PUSCH transmission 335 for transmitting to the second TRP 315. In some cases, the first DCI transmission 320 may schedule a first PDSCH transmission and the second DCI transmission 330 may schedule a second PDSCH transmission. In association with monitoring DCIs transmitted from the first TRP 310 and the second TRP 315, the UE 305 may monitor PDCCH candidates in PDCCH monitoring occasions in a quantity of different control resource sets (CORESETs), as configured by the network.

In some cases, the first TRP 310 may be associated with a serving cell of the UE 305. For example, the first TRP 310 may be a base station that provides the serving cell or a relay device that provides access to the serving cell. In some cases, a quantity of additional TRPs may be associated with a quantity of additional serving cells. In some cases, the second TRP 315 may be associated with a non-serving cell. To communicate with a cell and receive a DCI transmission, the UE 305 may acquire beam indications for beam selection based on a TCI state. In some cases, synchronization signal block (SSB) information may be used to perform channel measurement, obtain TCI state, or select beams for communication. The UE 305 may obtain SSB transmission position, SSB transmission periodicity, and SSB transmission power associated with the cell and use that information to facilitate receiving and decoding a DCI transmission.

In some scenarios, such as dual connectivity and/or carrier aggregation, different cells or uplink carriers may be configured in different timing advance groups (TAGs). A TAG may refer to a set of uplink carriers that have the same (or similar within a threshold value) timing advance (TA) values. For example, a first uplink carrier and a second uplink carrier may have different propagation delays between the UE 305 and TRP 310 and between the UE 305 and the TRP 315. For example, a first serving cell (e.g., a primary cell (PCell)) for the first uplink carrier may be associated with the first TRP 310, and a second serving cell (e.g., an SCell) for the second uplink carrier may be associated with the second TRP 315, which is not co-located with the first TRP 310, resulting in different propagation delays for uplink transmissions to reach a respective TRP 310 or 315 on the different uplink carriers. As a result, the first uplink carrier and the second uplink carrier may have different timing advance values for uplink transmissions and may belong to different TAGs.

A UE 305 may use a timing advance value for an uplink carrier to transmit an uplink communication on the uplink carrier with a timing that results in synchronization of TTIs with a TRP 310 or 315, to reduce inter-TTI interference.

Uplink carriers can be transmitted asynchronously or synchronously. Two or more of uplink carriers are typically synchronous when transmitted in the same subband. Two or more uplink carriers can be transmitted synchronously when a single TA command is used to control their timing. The transmission of two or more uplink carriers can be considered to be asynchronous with respect to one another when the transmission of one of the carriers lags the transmission of another of the carriers.

Multiple TAGs can be defined for the UE 305, which can be configured for carrier aggregation. A TAG typically comprises one or more uplink carriers controlled by the same TA commands transmitted from a TRP 310 and/or 315. TAGs can be configured by a serving TRP using dedicated signalling. A PDCCH order directed to an activated secondary cell in in a TAG can initiate a random access procedure that may result in the use of a physical random access channel (PRACH). A PDCCH order may be used, for example, after UL and DL resources have been released and the TRP 315 has DL data to send to the UE 305.

When multiple TAGs are defined for the UE 305, timing differences can exist between uplink carriers transmitted by the UE 305 because the one or more TAGS can have received a TA command different from the TA commands received by the other TAGs. TA commands can cause two or more TAGS to have timing offsets that are different from one another and these timing differences can be characterized as a relative delay between a pair of TAGs, or between corresponding component carriers, subframes, and/or symbols within the pair of TAGs.

In some cases, the UE 305 can follow the downlink frame timing change of a cell (which may be referred to as a “reference cell”) in a connected state. An uplink frame transmission can takes place (N_{TA}+N_{TAoffset})×T_{c} before reception of a first detected path (in time) of the corresponding downlink frame from the reference cell, where N_{TA} is a TA value obtained from a TA command, N_{TAoffset} is a TA offset value, and T_{c} is a configured periodicity. For serving cells in a primary TAG, the UE 305 can use a secondary primary cell as the reference cell for deriving the UE transmit timing for cells in the primary TAG. For serving cell(s) in a secondary TAG, the UE 305 can use any of the activated secondary cells as the reference cell for deriving the UE transmit timing for the cells in the secondary TAG.

For example, UEs may be configured to handle at least a relative timing difference between slot timings of all pairs of one or more specified TAGs, given that the UE is configured with the primary TAG and secondary TAG for inter-band NR carrier aggregation in standalone mode or dual connectivity mode and/or configured with more than one secondary TAG for inter-band NR carrier aggregation in dual connectivity modes. For intra-band non-contiguous NR carrier aggregation, UEs can be capable of handling at least a relative receive timing difference between slot timings of different carriers to be aggregated at the UE. For inter-band NR carrier aggregation, UEs can be capable of handling at least a relative receive timing difference between slot timing of all pairs of carriers to be aggregated at the UE.

In some cases, TA is indicated per component carrier but multi-DCI-based mTRP configurations can include multiple TRPs for each TA. However, UEs are often not configured to process timing parameters on a per-TRP basis. As a result, a UE might determine uplink transmission times based on a per-component carrier TA calculation, which, in an mTRP operation, can result in communications being missed. Thus, per-component carrier TA indications can result in loss of throughput and increased latency, thereby having a negative impact on network performance.

Some aspects of the techniques and apparatuses described herein provide for per-TA timing parameters for multi-DCI-based mTRP operations. For example, in some aspects, a UE may communicate, based at least in part on a multi-DCI-based mTRP configuration, with a first TRP in accordance with a first value, associated with the first TRP, of a timing parameter. The UE may communicate, based at least in part on the multi-DCI-based mTRP configuration, with a second TRP in accordance with a second value, associated with the second TRP, of the timing parameter. In this way, some aspects may facilitate the ability to determine and use TAs associated with multiple TRPs, thereby reducing the likelihood of missed communications and, as a result, having a positive impact on network performance.

As indicated above, FIG. 3 is provided as an example. Other examples may differ from what is described with regard to FIG. 3.

FIG. 4 is a diagram illustrating an example associated with timing parameters for multi-DCI-based mTRP configurations, in accordance with the present disclosure. As shown, a UE 405 may communicate with a first TRP 410 and a second TRP 415. In some aspects, the UE 405 may be similar to the UE 305 shown in FIG. 3. In some aspects, the TRP 410 and/or the TRP 415 may be similar to the TRP 310 and/or the TRP 315. The TRP 410 may be associated with a serving cell of the UE 405 and the TRP 415 may be associated with a non-serving cell of the UE 405.

As shown by reference number 420, the first TRP 410 may transmit, and the UE 405 may receive, a TAG configuration. In some aspects, the TAG configuration may configure the UE 405 with a primary TAG and a secondary TAG for inter-band carrier aggregation in at least one of standalone mode or dual connectivity mode. In some aspects, the TAG configuration may configure the UE 405 with a plurality of secondary TAGs for inter-band carrier aggregation in dual connectivity mode.

As shown by reference number 425, the UE 405 may communicate, based at least in part on a multi-DCI-based mTRP configuration, with a first TRP in accordance with a first value, associated with the first TRP, of a timing parameter. As shown by reference number 430, the UE 405 may communicate, based at least in part on the multi-DCI based mTRP configuration, with a second TRP in accordance with a second value, associated with the second TRP, of the timing parameter. The first TRP may be associated with a first value of a TRP indication parameter, and the second TRP may be associated with a second value of the TRP indication parameter. In some aspects, the TRP indication parameter may indicate at least one of a TRP ID, a CORESET pool index, a physical cell identity (PCI) ID, a closed loop index ID, and/or an SRS resource ID, among other examples.

In some aspects, the timing parameter may include a downlink timing parameter. In some aspects, for example, the first value of the timing parameter may indicate a frame timing change of the first TRP 410, and the second value of the timing parameter may indicate a frame timing change of the second TRP 415.

In accordance with one or more aspects of the present disclosure, a wireless communication standard may indicate that a UE (e.g., the UE 405) shall have a capability to follow the frame timing change of the reference cell, or the frame timing change of the TRP of the reference cell in connected state. The wireless communication standard also may indicate that the downlink timing is defined as the time when the first detected path (in time) of the corresponding downlink frame is received from the reference cell in cases of single TRP configuration or received associated with the TRP from the reference cell in cases of multi-DCI-based mTRP configuration.

For example, as shown by reference number 435, communicating with the first TRP 410 may include transmitting an uplink signal in an uplink frame based at least in part on the first value of the downlink timing parameter. As shown by reference number 440, the first TRP 410 may transmit, and the UE 405 may receive, associated with the first TRP and at a time instance indicated by the first value of the downlink timing parameter, a first detected path of a downlink frame corresponding to the uplink frame.

In some aspects, the timing parameter may include a maximum uplink transmission timing difference. In some aspects, the first value of the timing parameter may indicate a relative transmission timing difference between a slot timing of a first TAG associated with the first TRP and a slot timing of a second TAG associated with the first TRP. The second value of the timing parameter may indicate a relative transmission timing difference between a slot timing of a first TAG associated with the second TRP and a slot timing of a second TAG associated with the second TRP. In accordance with one or more aspects of the present disclosure, a wireless communication standard may indicate that a UE (e.g., the UE 405) shall be capable of handling at least a relative transmission timing difference between slot timing of all pairs of TAGs in cases of single TRP configuration, or between slot timings of all pairs of TAGs associated with the same TRP in cases of multi-DCI-based mTRP configuration.

In some aspects, the timing parameter may include a maximum receive timing difference. In some aspects, the first value of the timing parameter may indicate a relative receive timing difference between a slot timing of a first carrier associated with the first TRP and a slot timing of a second carrier associated with the first TRP. The first carrier and the second carrier may be aggregated at the UE 405 based at least in part on an intra-band non-contiguous carrier aggregation configuration. The second value of the timing parameter may indicate a relative receive timing difference between a slot timing of a third carrier associated with the second TRP and a slot timing of a fourth carrier associated with the second TRP. The third carrier and the fourth carrier may be aggregated at the UE based at least in part on the intra-band non-contiguous carrier aggregation configuration. In accordance with one or more aspects of the present disclosure, a wireless communication standard may indicate that a UE (e.g., the UE 405) shall be capable of handling at least a relative receive timing difference between slot timing of different carriers in cases of single TRP configuration, or between slot timing associated with the same TRP of different carriers to be aggregated at the UE in cases of multi-DCI-based mTRP configuration.

In some aspects, the first value of the timing parameter may indicate a relative receive timing difference between a slot timing of a first carrier associated with the first TRP and a slot timing of a second carrier associated with the first TRP. The first carrier and the second carrier may be aggregated at the UE 405 based at least in part on an inter-band carrier aggregation configuration. The second value of the timing parameter may indicate a relative receive timing difference between a slot timing of a third carrier associated with the second TRP and a slot timing of a fourth carrier associated with the second TRP. The third carrier and the fourth carrier may be aggregated at the UE 405 based at least in part on the inter-band carrier aggregation configuration. In accordance with one or more aspects of the present disclosure, a wireless communication standard may indicate that a UE (e.g., the UE 405) shall be capable of handling at least a relative receive timing difference between slot timing of all pairs of carriers in cases of single TRP configuration, or between slot timings associated with the same TRP of all pairs of carriers to be aggregated at the UE in cases of multi-DCI-based mTRP configuration.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with timing parameters for multi-DCI-based mTRP configurations.

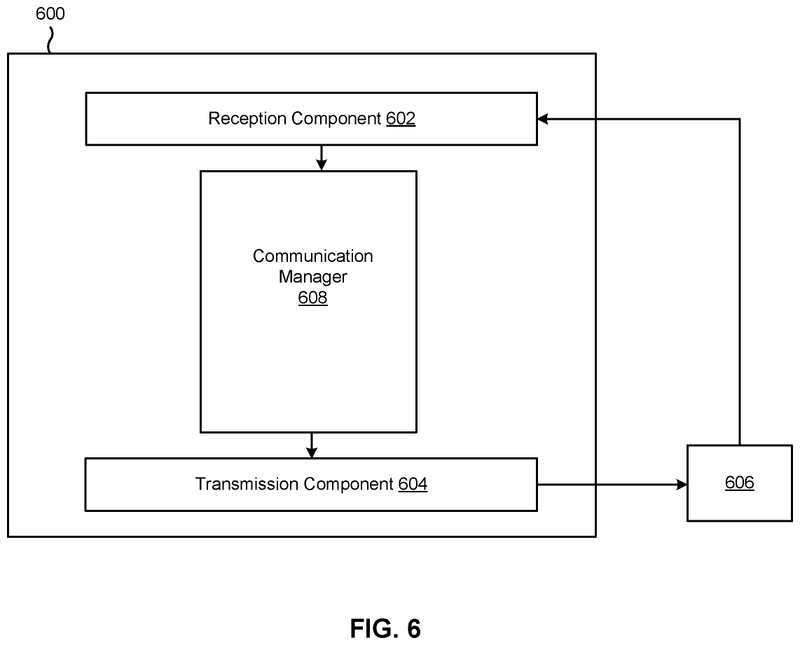

As shown in FIG. 5, in some aspects, process 500 may include communicating, based at least in part on a multi-DCI-based mTRP configuration, with a first TRP in accordance with a first value, associated with the first TRP, of a timing parameter (block 510). For example, the UE (e.g., using communication manager 608, depicted in FIG. 6) may communicate, based at least in part on a multi-DCI-based mTRP configuration, with a first TRP in accordance with a first value, associated with the first TRP, of a timing parameter, as described above.

As further shown in FIG. 5, in some aspects, process 500 may include communicating, based at least in part on the multi-DCI-based mTRP configuration, with a second TRP in accordance with a second value, associated with the second TRP, of the timing parameter (block 520). For example, the UE (e.g., using communication manager 608, reception component 602, and/or transmission component 604, depicted in FIG. 6) may communicate, based at least in part on the multi-DCI-based mTRP configuration, with a second TRP in accordance with a second value, associated with the second TRP, of the timing parameter, as described above.

Process 500 may include additional aspects, such as any single aspect or any combination of aspects described below and/or in connection with one or more other processes described elsewhere herein.

In a first aspect, the timing parameter comprises a downlink timing parameter. In a second aspect, alone or in combination with the first aspect, communicating with the first TRP comprises transmitting an uplink signal in an uplink frame based at least in part on the first value of the downlink timing parameter, and receiving, associated with the first TRP and at a time instance indicated by the first value of the downlink timing parameter, a first detected path of a downlink frame corresponding to the uplink frame.

In a third aspect, alone or in combination with one or more of the first and second aspects, the first value of the timing parameter indicates a frame timing change of the first TRP, and wherein the second value of the timing parameter indicates a frame timing change of the second TRP. In a fourth aspect, alone or in combination with one or more of the first through third aspects, the timing parameter comprises a maximum uplink transmission timing difference.

In a fifth aspect, alone or in combination with one or more of the first through fourth aspects, the first value of the timing parameter indicates a relative transmission timing difference between a slot timing of a first TAG associated with the first TRP and a slot timing of a second TAG associated with the first TRP, and wherein the second value of the timing parameter indicates a relative transmission timing difference between a slot timing of a first TAG associated with the second TRP and a slot timing of a second TAG associated with the second TRP. In a sixth aspect, alone or in combination with the fifth aspect, the UE is configured with a primary TAG and a secondary TAG for inter-band carrier aggregation in at least one of standalone mode or dual connectivity mode. In a seventh aspect, alone or in combination with one or more of the fifth or sixth aspects, the UE is configured with a plurality of secondary TAGs for inter-band carrier aggregation in dual connectivity mode.

In an eighth aspect, alone or in combination with one or more of the first through seventh aspects, the timing parameter comprises a maximum receive timing difference. In a ninth aspect, alone or in combination with one or more of the first through eighth aspects, the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an intra-band non-contiguous carrier aggregation configuration, and wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the intra-band non-contiguous carrier aggregation configuration.

In a tenth aspect, alone or in combination with one or more of the first through ninth aspects, the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an inter-band carrier aggregation configuration, and wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the inter-band carrier aggregation configuration.

In an eleventh aspect, alone or in combination with one or more of the first through tenth aspects, the first TRP is associated with a first value of a TRP indication parameter, and wherein the second TRP is associated with a second value of the TRP indication parameter, the TRP indication parameter indicating at least one of a TRP ID, a CORESET pool index, a PCI ID, a closed loop index ID, or an SRS resource ID.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a communication manager 608.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The communication manager 608, the reception component 602, and/or the transmission component 604 may communicate, based at least in part on a multi-DCI-based mTRP configuration, with a first TRP in accordance with a first value, associated with the first TRP, of a timing parameter. The communication manager 608, the reception component 602, and/or the transmission component 604 may communicate, based at least in part on the multi-DCI-based mTRP configuration, with a second TRP in accordance with a second value, associated with the second TRP, of the timing parameter.

The communication manager 608 may control and/or otherwise manage one or more operations of the reception component 602 and/or the transmission component 604. In some aspects, the communication manager 608 may include one or more antennas, a modem, a controller/processor, a memory, or a combination thereof, of the UE described in connection with FIG. 2. The communication manager 608 may be, or be similar to, the communication manager 140 depicted in FIGS. 1 and 2. For example, in some aspects, the communication manager 608 may be configured to perform one or more of the functions described as being performed by the communication manager 140. In some aspects, the communication manager 608 may include the reception component 602 and/or the transmission component 604.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user equipment (UE), comprising: communicating, based at least in part on a multi-downlink control information (DCI)-based multiple transmit-receive-point (mTRP) configuration, with a first TRP in accordance with a first value, associated with the first TRP, of a timing parameter; and communicating, based at least in part on the multi-DCI-based mTRP configuration, with a second TRP in accordance with a second value, associated with the second TRP, of the timing parameter.

Aspect 2: The method of Aspect 1, wherein the timing parameter comprises a downlink timing parameter.

Aspect 3: The method of Aspect 2, wherein communicating with the first TRP comprises: transmitting an uplink signal in an uplink frame based at least in part on the first value of the downlink timing parameter; and receiving, associated with the first TRP and at a time instance indicated by the first value of the downlink timing parameter, a first detected path of a downlink frame corresponding to the uplink frame.

Aspect 4: The method of any of Aspects 1-3, wherein the first value of the timing parameter indicates a frame timing change of the first TRP, and wherein the second value of the timing parameter indicates a frame timing change of the second TRP.

Aspect 5: The method of any of Aspects 1-4, wherein the timing parameter comprises a maximum uplink transmission timing difference.

Aspect 6: The method of any of Aspects 1-5, wherein the first value of the timing parameter indicates a relative transmission timing difference between a slot timing of a first timing advance group (TAG) associated with the first TRP and a slot timing of a second TAG associated with the first TRP, and wherein the second value of the timing parameter indicates a relative transmission timing difference between a slot timing of a first TAG associated with the second TRP and a slot timing of a second TAG associated with the second TRP.

Aspect 7: The method of Aspect 6, wherein the UE is configured with a primary TAG and a secondary TAG for inter-band carrier aggregation in at least one of standalone mode or dual connectivity mode.

Aspect 8: The method of either of Aspects 6 or 7, wherein the UE is configured with a plurality of secondary TAGs for inter-band carrier aggregation in dual connectivity mode.

Aspect 9: The method of any of Aspects 1-8, wherein the timing parameter comprises a maximum receive timing difference.

Aspect 10: The method of any of Aspects 1-9, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an intra-band non-contiguous carrier aggregation configuration, and wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the intra-band non-contiguous carrier aggregation configuration.

Aspect 11: The method of any of Aspects 1-9, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an inter-band carrier aggregation configuration, and wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the inter-band carrier aggregation configuration.

Aspect 12: The method of any of Aspects 1-11, wherein the first TRP is associated with a first value of a TRP indication parameter, and wherein the second TRP is associated with a second value of the TRP indication parameter, the TRP indication parameter indicating at least one of: a TRP identifier (ID), a control resource set pool index, a physical cell identity ID, a closed loop index ID, or a sounding reference signal resource ID.

Aspect 13: An apparatus for wireless communication at a device, comprising a processor; memory coupled with the processor; and instructions stored in the memory and executable by the processor to cause the apparatus to perform the method of one or more of Aspects 1-12.

Aspect 14: A device for wireless communication, comprising a memory and one or more processors coupled to the memory, the one or more processors configured to perform the method of one or more of Aspects 1-12.

Aspect 15: An apparatus for wireless communication, comprising at least one means for performing the method of one or more of Aspects 1-12.

Aspect 16: A non-transitory computer-readable medium storing code for wireless communication, the code comprising instructions executable by a processor to perform the method of one or more of Aspects 1-12.

Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
communicate, based at least in part on a multi-downlink control information (DCI)-based multi-transmit-receive-point (mTRP) configuration, with a first TRP in accordance with a first value, associated with the first TRP, of a timing parameter; and
communicate, based at least in part on the multi-DCI based mTRP configuration, with a second TRP in accordance with a second value, associated with the second TRP, of the timing parameter.

2. The UE of claim 1, wherein the timing parameter comprises a downlink timing parameter.

3. The UE of claim 2, wherein the one or more processors, to communicate with the first TRP, are configured to:
transmit an uplink signal in an uplink frame based at least in part on the first value of the downlink timing parameter; and
receive, associated with the first TRP and at a time instance indicated by the first value of the downlink timing parameter, a first detected path of a downlink frame corresponding to the uplink frame.

4. The UE of claim 1, wherein the first value of the timing parameter indicates a frame timing change of the first TRP, and wherein the second value of the timing parameter indicates a frame timing change of the second TRP.

5. The UE of claim 1, wherein the timing parameter comprises a maximum uplink transmission timing difference.

6. The UE of claim 1, wherein the first value of the timing parameter indicates a relative transmission timing difference between a slot timing of a first timing advance group (TAG) associated with the first TRP and a slot timing of a second TAG associated with the first TRP, and wherein the second value of the timing parameter indicates a relative transmission timing difference between a slot timing of a first TAG associated with the second TRP and a slot timing of a second TAG associated with the second TRP.

7. The UE of claim 6, wherein the UE is configured with a primary TAG and a secondary TAG for inter-band carrier aggregation in at least one of standalone mode or dual connectivity mode.

8. The UE of claim 6, wherein the UE is configured with a plurality of secondary TAGs for inter-band carrier aggregation in dual connectivity mode.

9. The UE of claim 1, wherein the timing parameter comprises a maximum receive timing difference.

10. The UE of claim 1, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an intra-band non-contiguous carrier aggregation configuration, and
wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the intra-band non-contiguous carrier aggregation configuration.

11. The UE of claim 1, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an inter-band carrier aggregation configuration, and
wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the inter-band carrier aggregation configuration.

12. The UE of claim 1, wherein the first TRP is associated with a first value of a TRP indication parameter, and wherein the second TRP is associated with a second value of the TRP indication parameter, the TRP indication parameter indicating at least one of:
a TRP identifier (ID),
a control resource set pool index,
a physical cell identity ID,
a closed loop index ID, or
a sounding reference signal resource ID.

13. A method of wireless communication performed by a user equipment (UE), comprising:
communicating, based at least in part on a multi-downlink control information (DCI)-based multi-transmit-receive-point (mTRP) configuration, with a first TRP in accordance with a first value, associated with the first TRP, of a timing parameter; and
communicating, based at least in part on the multi-DCI-based mTRP configuration, with a second TRP in accordance with a second value, associated with the second TRP, of the timing parameter.

14. The method of claim 13, wherein the timing parameter comprises a downlink timing parameter.

15. The method of claim 14, wherein communicating with the first TRP comprises:
transmitting an uplink signal in an uplink frame based at least in part on the first value of the downlink timing parameter; and
receiving, associated with the first TRP and at a time instance indicated by the first value of the downlink timing parameter, a first detected path of a downlink frame corresponding to the uplink frame.

16. The method of claim 13, wherein the first value of the timing parameter indicates a frame timing change of the first TRP, and wherein the second value of the timing parameter indicates a frame timing change of the second TRP.

17. The method of claim 13, wherein the timing parameter comprises a maximum uplink transmission timing difference.

18. The method of claim 13, wherein the first value of the timing parameter indicates a relative transmission timing difference between a slot timing of a first timing advance group (TAG) associated with the first TRP and a slot timing of a second TAG associated with the first TRP, and wherein the second value of the timing parameter indicates a relative transmission timing difference between a slot timing of a first TAG associated with the second TRP and a slot timing of a second TAG associated with the second TRP.

19. The method of claim 18, wherein the UE is configured with a primary TAG and a secondary TAG for inter-band carrier aggregation in at least one of standalone mode or dual connectivity mode.

20. The method of claim 18, wherein the UE is configured with a plurality of secondary TAGs for inter-band carrier aggregation in dual connectivity mode.

21. The method of claim 13, wherein the timing parameter comprises a maximum receive timing difference.

22. The method of claim 13, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an intra-band non-contiguous carrier aggregation configuration, and
wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the intra-band non-contiguous carrier aggregation configuration.

23. The method of claim 13, wherein the first value of the timing parameter indicates a relative receive timing difference between a slot timing of a first carrier associated with the first TRP and a slot timing of a second carrier associated with the first TRP, wherein the first carrier and the second carrier are aggregated at the UE based at least in part on an inter-band carrier aggregation configuration, and
wherein the second value of the timing parameter indicates a relative receive timing difference between a slot timing of a third carrier associated with the second TRP and a slot timing of a fourth carrier associated with the second TRP, wherein the third carrier and the fourth carrier are aggregated at the UE based at least in part on the inter-band carrier aggregation configuration.

24. The method of claim 13, wherein the first TRP is associated with a first value of a TRP indication parameter, and wherein the second TRP is associated with a second value of the TRP indication parameter, the TRP indication parameter indicating at least one of:
a TRP identifier (ID),
a control resource set pool index,
a physical cell identity ID,
a closed loop index ID, or
a sounding reference signal resource ID.

25. A non-transitory computer-readable medium storing a set of instructions for wireless communication, the set of instructions comprising:
one or more instructions that, when executed by one or more processors of a user equipment (UE), cause the UE to:
communicate, based at least in part on a multi-downlink control information (DCI)-based multi-transmit-receive-point (mTRP) configuration, with a first TRP in accordance with a first value, associated with the first TRP, of a timing parameter; and
communicate, based at least in part on the multi-DCI-based mTRP configuration, with a second TRP in accordance with a second value, associated with the second TRP, of the timing parameter.

26. The non-transitory computer-readable medium of claim 25, wherein the timing parameter comprises at least one of:
a downlink timing parameter,
a maximum uplink transmission timing difference, or
a maximum receive timing difference.

27. The non-transitory computer-readable medium of claim 25, wherein the first TRP is associated with a first value of a TRP indication parameter, and wherein the second TRP is associated with a second value of the TRP indication parameter, the TRP indication parameter indicating at least one of:
a TRP identifier (ID),
a control resource set pool index,
a physical cell identity ID,
a closed loop index ID, or
a sounding reference signal resource ID.

28. An apparatus for wireless communication, comprising:
means for communicating, based at least in part on a multi-downlink control information (DCI)-based multi-transmit-receive-point (mTRP) configuration, with a first TRP in accordance with a first value, associated with the first TRP, of a timing parameter; and
means for communicating, based at least in part on the multi-DCI-based mTRP configuration, with a second TRP in accordance with a second value, associated with the second TRP, of the timing parameter.

29. The apparatus of claim 28, wherein the timing parameter comprises at least one of:
a downlink timing parameter,
a maximum uplink transmission timing difference, or
a maximum receive timing difference.

30. The apparatus of claim 28, wherein the first TRP is associated with a first value of a TRP indication parameter, and wherein the second TRP is associated with a second value of the TRP indication parameter, the TRP indication parameter indicating at least one of:
a TRP identifier (ID),
a control resource set pool index,
a physical cell identity ID,
a closed loop index ID, or
a sounding reference signal resource ID.
